(19) United States
(12) Patent Application Publication
(10) Pub. No.: US 2006/0153356 A1
(43) Pub. Date: Jul. 13, 2006

(54) Contact-center routing based on incentives and/or agent preferences

(75) Inventors: Michael E. Sisselman, New York, NY (US); Ward Whitt, New York, NY (US)

Correspondence Address: SWIDLER BERLIN LLP, 3000 K STREET, NW, BOX IP, WASHINGTON, DC, 20007, US

(73) Assignee: SeatLink, Inc.

(21) Appl. No.: 11/033,638

(22) Filed: Jan. 13, 2005

(51) Int. Cl. H04M 3/00

(52) U.S. Cl. 379/265.12

(57) ABSTRACT

A new routing protocol for routing service requests in a contact center is provided that takes into account agent preferences. Agents identify their preferences for handling particular types of service requests. The routing protocol takes account of those preferences while still routing calls in a systematic, coordinated and efficient manner. Additionally, management may communicate incentives dynamically to agents to incentivize agents to change their preferences in ways that corresponds to management priorities. Management may further influence routing by adjusting management preferences, which may be taken into account along with agent preferences when routing calls. By incorporating agent preferences in the routing scheme, agents are given more control over their work, thus tending to increase job satisfaction and therefore agent retention and contact-center performance.

### FIELD OF THE INVENTION

The present invention relates to contact-center routing and, more particularly, relates to routing associated with a contact center pursuant to which agent preferences are used to influence the routing of service requests to agents and wherein management preferences and incentives provided by management may be used dynamically to influence agent preferences and/or the routing.

### BACKGROUND OF THE INVENTION

A contact center is a collection of resources providing an interface between a service provider and its remote customers. Contact centers have become important vehicles for service providers to reach and interact with customers. Examples of contact centers are those provided by 911 operators, catalog retail stores and technical support organizations.

A primary resource in a contact center is the group of people who respond to service requests, the customer service representatives, referred to herein as agents. While the classical contact center is the telephone call center, where the interactions are telephone calls, the nature of contact centers has evolved so that the telephone is no longer the only way for a customer to interact with a contact center. The environment of a typical call center is a large room filled with cubicles, in which agents wearing telephone headsets sit before computer screens, which provide supporting information. The agents respond to service requests by answering arriving (inbound) telephone calls. The agents may also place outbound calls, or handle automatically generated calls, on behalf of the service provider, as occurs in telemarketing. Alternative media such as email, fax, web pages and web chat are on the rise.

Contact centers are supported by information-and-communication-technology (ICT) equipment, such as a private branch exchange (PBX), an automatic call distributor (ACD), personal computers (PC's), networks and assorted database systems. The ICT technology has increased the flexibility of contact centers making it possible not only to have agents in a single building, but when desired to have agents distributed over multiple buildings, multiple contact centers or the agents' individual homes.

Contact centers typically handle several different kinds of interactions for one or more organizations. For example, telephone callers may speak different languages, call about different promotions or call to speak with one or more separate departments, i.e. billing vs. sales. A single contact center may be associated with a single entity, such as an airline. Alternatively, a contact center may be independently operated and provide agents to support several different service providers. The latter may occur when service providers outsource their contact centers. Grouping together several different contact centers into one can be advantageous, because it facilitates economies of scale.

Several routing techniques have been developed to ensure that agents respond promptly to calls. Load-based routing has been used to try to enable the workload to be shared equitably among agents. According to load-based routing, a new service request, such as a call, may be assigned to the agent that has been idle the longest. As an illustrative example, consider a consumer-electronics contact center. The service requests handled by the contact center may be classified into three types: sales inquiry, technical support and customer service. The agents belong to a single agent pool, with each agent handling every type of service request. When several of the agents are idle, new service requests are assigned to the agent that has been idle the longest. When all of the agents are engaged, each new service request waits in a queue. When an agent finishes handling a service request, the routing system routes another service request to the agent, if any are waiting. The agent would be assigned the service request that has been waiting the longest, whatever the type.

A problem with load-based routing is that it is rarely possible or cost-effective to have every agent capable of handling every type of service request. This is because agents tend to have different skills, in different combinations and training (at a cost) is required to enhance or expand an agent's skills.

Another technique for routing calls or service requests in a call center is skill-based routing. In contrast to load-based routing, skill-based routing is designed to ensure that service requests are not only handled promptly but are also properly resolved by an agent having appropriate skills. According to skill-based routing, each agent is given a static agent profile that identifies the agent's skills, which correspond to different types of service requests. Agents may have more than one skill and training agents may result in expanding the skills of the agent. Agents also may have skills at different priority levels. Thus, for each service request type, some agents may have a corresponding skill as a primary skill, some may have it as a secondary skill, and the remainder will not have a corresponding skill at all. Service requests of a particular type are generally not routed to agents without corresponding skills. However, when a customer's wait time exceeds a predetermined threshold, routing to an available agent without corresponding skills may nonetheless occur.

According to skill-based routing, when a new call arrives, the call is classified and then routed to an available agent having a corresponding skill listed as a primary skill and who has been idle the longest. However, if no agents having the required skill as a primary skill are available, then the new service request would be handled by the agent having that skill as a secondary skill who has been idle the longest. If no agent having that skill at either priority level is available, then the new service request waits in queue for an appropriate agent to become free. When an agent finishes handling a service request, he serves the waiting request that has been waiting the longest among those in one of his primary skills. If there are no customers waiting in one of his primary skills, he serves the waiting request that has been waiting the longest among those in one of his secondary skills. If no customers are waiting among the classes for which he has skills, then the agent remains idle, unless the longest waiting time exceeds a threshold. If the customer waiting time exceeds that high threshold, the agent responds to that service request, even though the agent may not have the required skill. The agent may then make arrangements for a more skilled agent to call back at a later time.

Still other routing techniques and call center technology include: identifying the caller and attempting to route the caller to the same agent that has previously handled the caller's calls; providing a system for training agents to enhance or provide new skills during an agent's idle time; and prioritizing routing based on attributes of the caller, such as money spent with the service provider or types of products purchased.

Still another routing technique allows a caller or agent to view information on available calls in a call center queue and to allow the agents or the caller to preempt the routing algorithm by taking calls out of queue order or placing the call in a different queue. This technique may cause uncoordinated and unsystematic routing by undermining the routing algorithm.

Despite the apparent advantages of skill-based routing and other techniques described above, contact centers often are not able to meet performance objectives. Reasons for the failure to achieve objectives frequently relate to the performance of the agent workforce. It is difficult, for example, to maintain an energized, experienced, effective workforce because of: high turnover or chum among agents (poor retention), high absenteeism (poor attendance), high schedule deviation (poor schedule adherence), and high fatigue (poor endurance).

Contact centers generally report between 20% to 200% annual turnover among agents. There are significant costs associated with high turnover, including transition costs and productivity costs. Transition costs account for the per-agent cost of terminating the departing agent, recruiting and training the new agent to replace the departing one, and disruption costs associated with the change, such as the cost of hiring a temporary employee, and the costs of managers coping with the change, such as the cost of performing exit interviews, the administrative cost of stopping benefit deductions and starting benefit enrollments. It has been estimated that transition costs alone can be as much as 100%-200% of an agent's annual compensation.

Productivity costs are also significant. Because new agents typically must undergo a significant start-up learning period in order to perform effectively, high turnover tends to produce an inexperience pool of agents that performs less efficiently than an experienced pool. Moreover, high turnover generally indicates agents are dissatisfied with their job and job dissatisfaction inevitably makes the agent a less effective worker.

Unfortunately, while call center technology such as load-based routing and skill-based routing tends to improve call center performance, the technology does not address how to lessen agent turnover or improve an agent's work experience. Moreover, attempts to address workforce problems with technology to date generally have placed additional demands and pressure on agents. The following factors also tend to put pressure on agents and tend to increase agent turnover, absenteeism, schedule deviation and shift fatigue: staffing agents in massive call centers with hundreds or thousands of agents; using agent idle time for automatic training routines; forcing agents to use predetermined scripts for interactions; and monitoring agents by recording calls.

Accordingly, there is a need for a new system and method for routing calls that allows systematic, coordinated routing of service requests in a contact center that also tends to alleviate workforce problems. There is a further need for a system and method for routing calls that involves the agents in the routing process, while still allowing calls to be routed according to management priorities. There is still a further need for a system and method for routing calls in a contact center that allows management to motivate agents in a dynamic way to meet changing service request demands and agent workforce needs.

### SUMMARY OF THE INVENTION

According to the present invention, a new routing protocol for routing service requests in a contact center is provided that takes into account agent preferences. In particular, agents identify their preferences for handling particular types of service requests. The routing protocol takes account of those preferences while still routing calls in a systematic, coordinated and efficient manner. Additionally, management may communicate incentives dynamically to agents to motivate agents to change their preferences in ways that corresponds to management priorities. Management may further influence routing by adjusting management preferences, which may be taken into account along with agent preferences when routing calls.

By incorporating agent preferences in the routing, the invention gives agents more control over their work, thus tending to increase job satisfaction and therefore agent retention. At the same time, management is given the ability to influence agents and routing in a dynamic manner. The additional interaction between management and agents has a tendency to involve agents in the routing process, improve alertness and generally improve the performance and job satisfaction among agents. Increased agent retention over time is expected to increase the average level of experience among a pool of agents and thus improve the performance of contact centers. In addition, agent preferences may be applied to agent availability to allow agents to increase or decrease their availability when they are presently staffed under certain circumstances and to allow agents to increase or decrease their staffing according to their preferences under certain circumstances.

Thus the routing protocols according to embodiments of the present invention go beyond both load-based routing and skill-based routing to achieve routing based on agent preferences and when desired preference based staffing. These routing protocols, based on agent preferences, make it possible to not only respond to calls promptly (load-based routing) and properly (skill-based routing), but also provide more job satisfaction to agents, thus leading to improved agent sense of wellbeing in the workplace, higher agent retention and attendance, and ultimately more satisfied customers as a result. Embodiments of the present invention may be used to implement a new automatic call distributor (ACD), or similar routing system, or may be used to work with an existing ACD or routing system.

According to one embodiment of the present invention, an apparatus affects call routing by an automatic call distributor (ACD) and includes a database and a server. The database stores agent preferences associated with agents. The server communicates with the database and is capable of receiving preferences from agent terminals and storing the preferences in the database. The server further provides preference information corresponding to the agent preferences to the ACD to permit call routing by the ACD based on the agent preferences. The ACD may be implemented as a hosted-on demand system servicing multiple contact centers or may be dedicated to a single contact center.

According to another embodiment of the present invention, an apparatus routes incoming service requests to agents and includes a database and a routing system. The database associates at least one agent preference with a corresponding agent. The routing system is coupled to the database, receives incoming service requests and agent preferences from the database and determines to which agent to route the service requests based on the agent preferences. This apparatus may be used to replace an existing ACD. The routing system may be implemented as a hosted, on-demand routing system servicing multiple contact centers or may be dedicated to a single contact center.

According to still another embodiment of the present invention, a method routes incoming service requests to agents and includes: i) associating at least one agent preference with a corresponding agent among a plurality of agents; ii) receiving service requests; and iii) determining to which agent to route the service requests based on the agent preferences.

According to still another embodiment of the present invention, a computer program product has computer program logic stored therein for routing service requests. The computer program logic includes: i) associating logic for causing a computer to associate at least one agent preference with a corresponding agent among a plurality of agents; ii) receiving logic for causing the computer to receive information about service requests; and iii) determining logic for causing the computer to determine to which agent to route the incoming calls based on the information and the agent preferences.

According to still another embodiment of the present invention, an apparatus for affecting call routing includes a database and a server. The database stores agent preferences for agents, wherein each agent is associated with a particular organization and wherein the database stores agent preferences for a plurality of organizations. The server is capable of communication with the database and a plurality of ACDs corresponding to a plurality of organizations and is capable of receiving preferences from agent terminals and storing the preferences in the database. The server further provides the preference information for each agent to each ACD to permit service request routing by a plurality of ACDs to be performed based on the agent preferences, thereby providing a hosted, on-demand preference system.

According to still another embodiment of the present invention, routing of service requests is influenced by determining incentives for agents, sending the incentives to the agents, and receiving preferences from the agents. The preferences thus received are used to affect the routing of incoming calls to agents. The incentives and preferences may be dynamically changed thus permitting the use of incentives, for example by contact-center management, to influence agent preferences and therefore control routing and agent performance within the contact center. Collecting agent preferences and the provision of incentives to influence those agent preferences may be implemented in numerous ways without limitation. Illustratively, the preference system may: continually allow agents and management adjust their preferences and incentives respectively; allow agents and management to adjust their respective preferences and incentives in rounds; allow agents to accumulate points in response to various aspects of the agents' performance and in response to the expression of the agents' preferences; allow agents to redeem points accumulated; allow agents to compete against other agents through performance and/or declarations of agent preferences; and or otherwise establish procedures pertaining to the expression of agent preferences.

### BRIEF DESCRIPTION OF THE FIGURES

The above described features and advantages of the present invention will be more fully appreciated with reference to the accompanying detailed description and figures, in which:

FIG. 1 depicts a contact center and associated devices incorporating a preference system and a separate routing system influenced by the preference system according to an embodiment of the present invention.

FIG. 2 depicts a contact center and associated devices incorporating a preference routing system according to an embodiment of the present invention.

FIG. 3A depicts a hosted, on-demand preference system for coordinating preference based routing among a plurality of remotely located routing systems.

FIG. 3B depicts a hosted, on-demand preference routing system for implementing routing based on agent preferences among a plurality of remotely located agents with different agent affiliations and/or different locations.

FIG. 4 depicts a contact center and associated devices incorporating an agent reward system according to an embodiment of the present invention.

FIG. 5 depicts databases associated with a routing protocol used to route service requests according to an embodiment of the present invention.

FIG. 6 depicts a method of updating an agent's profile according to an embodiment of the present invention.

FIG. 7 depicts a method of routing a new service request, such as a call, received by a contact center according to an embodiment of the present invention.

FIG. 8 depicts a method of routing a service request, such as a call, from a service request queue within a contact center to an agent after the agent completes a service request, or finishes handling a service request according to an embodiment of the present invention.

FIG. 9 depicts a method of routing a service request, such as a call, from a service request queue within a contact center to an agent after an idle agent becomes available according to an embodiment of the present invention.

FIG. 10 depicts a method of routing a service request, such as a, call that has waited too long from a service request queue to an available agent according to an embodiment of the present invention.

FIG. 11 depicts a method of dynamically influencing routing within a contact center based on incentives and agent preferences and other available information and constraints according to an embodiment of the present invention.

FIG. 12 depicts a method of monitoring and providing rewards to agents according to an embodiment of the present invention.

### DETAILED DESCRIPTION

According to the present invention, a new routing protocol for routing service requests in a contact center is provided that takes into account agent preferences. In particular, agents identify their preferences for handling particular types of service requests. The routing protocol takes account of those preferences while still routing calls in a systematic, coordinated and efficient manner. Additionally, management may communicate incentives dynamically to agents to incentivize agents to change their preferences in ways that corresponds to management priorities. Management may further influence routing by expressing management preferences, which may be taken into account along with agent preferences when routing calls.

By incorporating agent preferences in the routing, the invention gives agents more control over their work, thus tending to increase job satisfaction and therefore agent retention. At the same time, management is given the ability to influence agents and routing in a dynamic manner. The additional interaction between management and agents has a tendency to involve agents in the routing process, improve alertness and generally improve job satisfaction among agents. As used herein, the term “agent preference” refers to a preference expressed by an agent with respect to one or more parameters that are involved in service request routing, including the degree to which the agent wants to handle different types of calls expressed as a cardinal or ordinal value. “Agent preferences” refers to more than one preference expressed by an agent with respect to one or more corresponding parameters that are involved in service request routing.

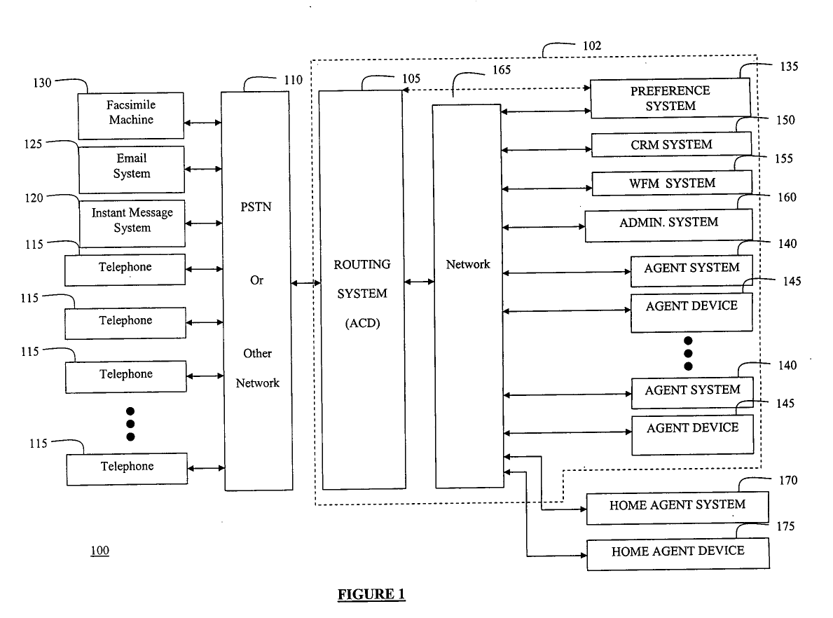

FIG. 1 depicts a service request communication system 100 facilitated by a contact center 102 incorporating a preference system 135 according to an embodiment of the present invention. Referring to FIG. 1, the contact center includes a routing system 105 coupled between a public switched telephone network (PSTN) or other network 110 and a network 165. The routing system receives service requests via the network 110 from any of several types of devices, including telephones 115, instant messaging systems 120, email systems 125 and/or facsimile machines 130. Customers of the service provider serviced by the contact center use the devices 115 - 130 to interact with agents that work with the contact center 102. While the boundaries of the contact center are indicated with a dashed line, it will be understood that any of the devices and systems shown in FIG. 1 may be implemented on site with the routing system 105 or may be separately located.

The routing system 105 is coupled via the network 165 to a plurality of agent systems 140 and agent devices 145, a preference system 135, a customer relations management (CRM) system 150, and a workforce management (WFM) system 155. Additionally, one or more home agent systems 170 and home agent devices 175 may be coupled to the routing system via the network 165. The agent systems and devices are utilized by agents to interact with customers in a systematic manner coordinated by the routing system 105. The agent systems may be computer systems or any other type of device capable of receiving and conveying information. The agent device may be a telephone, a headset, or any other device that enables interaction between the agent and the routing system.

The routing system 105 itself may be any type of switching system capable of receiving communications from customers and conveying them to agents in a controlled manner. The routing system may be, for example, an automatic call distribution system (ACD), a private branch exchange system (PBX), a packet switch or other type of switch, analog or digital. In general, the routing system is controlled by a routing protocol which may be associated with the routing system itself or may be embodied in any device on the network capable of communicating control information to the routing system. According to one embodiment of the present invention, the routing performed by the routing system 105 is influenced by agent preferences and the preference system 135 plays a key role in establishing this influence. This is described in further detail below in the context of illustrative routing protocols and the dynamic process of declaring agent preferences.

The networks 110 and 165 (and any other network described herein) may each be a local area network, a wide area network, the public switched telephone network, the interconnected backbones, routers, bridges, switches and servers known as the Internet, other communications links and combinations thereof. The network may include direct electrical connections, wireless, optical or any other communications links, including analog, digital, circuit switched and packet switched, for transmitting information. The networks 110 and 165 may be distinct from one another as shown and may each include multiple networks. It also will be understood that these networks may be one in the same.

The preference system 135 is coupled to the network 165 and may be a server or other general purpose computer that runs computer programs. The preference system 135 may be used to interact with any and all of the systems shown in FIG. 1, including the agent systems and devices in order to permit the agents to update their preferences for handling particular types of service requests. The preference system 135 may interact with management either directly or via a separate administrative system 160 to allow management to provide update incentives or management preferences. The preference system is in communication with the routing system 105 and thus has access to network conditions from the routing system. The preference system also interacts with the routing system to allow the preference system to influence routing being performed by the routing system to account for agent preferences and other parameters.

In addition, the preference system 135 may interact with workforce management system 155 in order to obtain work schedules and/or agent forecasting information and the CRM system 150 in order to receive information about how business objectives are being met, system performance or other measures. The preference system may provide network conditions or performance information to management or agents in order to allow management to adjust incentives or management preferences based on this information and/or to allow agents to adjust agent preferences in view of the incentives, management preferences, network condition information, performance information or work schedule and/or forecasting information. The preference system stores the agent preferences and in some cases management preferences in a database in order to allow these preferences to be available to influence service request routing within a contact center.

The CRM system 150 is used to monitor that customers are being served appropriately and that business objectives are being met. The CRM system thus may collect and store a variety of information relating to a contact center, such as customer information, including a history of previous interactions of each customer and performance information. The customer information may be provided to agent systems 140 prior to connecting a service request from a customer to an agent so that the agent has customer information available when handling the service request. Performance information may also be provided to agent systems 140 and management systems.

The WFM system 155 is used to ensure that the proper number of agents with the right skills are accessible by the contact center at the right time. WFM systems are provided by companies such as IEX, Inc. and Blue Pumpkin, Inc. In general, the WFM system establishes forecasting, staffing and scheduling information with respect to workload and agents and also may store and provide information that is useful in assessing agent performance and agent compensation. The forecasting, staffing and scheduling information may be communicated to the preference system, routing system and/or management system and/or databases that store this information for use by contact-center systems.

The administrative system 160 may be any computer system or other input/output device that may be used by management to interact with any of the various devices and systems shown in FIG. 1. In particular, the administrative system 160 may be used by management: to declare management preferences, constraints on routing or incentives; or to monitor any aspect of performance of the contact center 105.

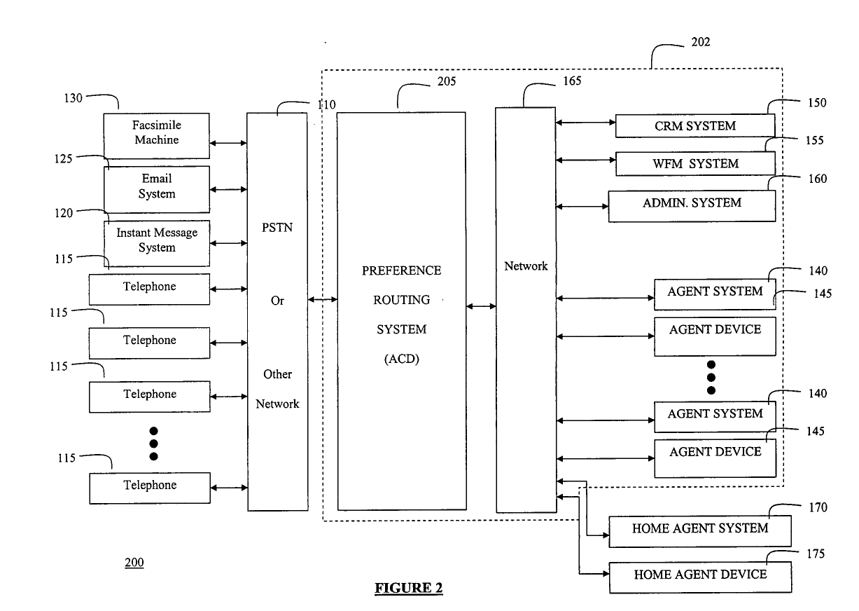

FIG. 2 depicts a service request communication system 200 facilitated by a contact center 202 incorporating a preference routing system 205 according to another embodiment of the invention. The contact center according to FIG. 2 is configured in the same manner as that shown in FIG. 1 with one exception. Rather than having a separate preference system 135, preference based routing is incorporated into a preference routing system 205. The preference routing system may be an ACD, PBX or other switching system.

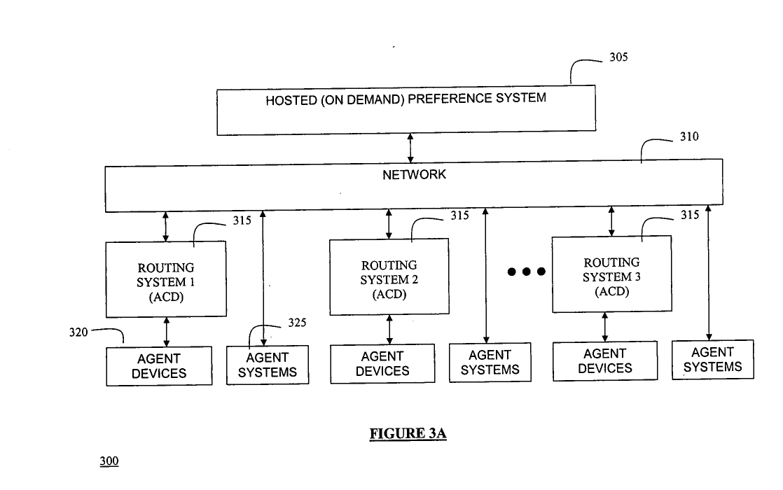

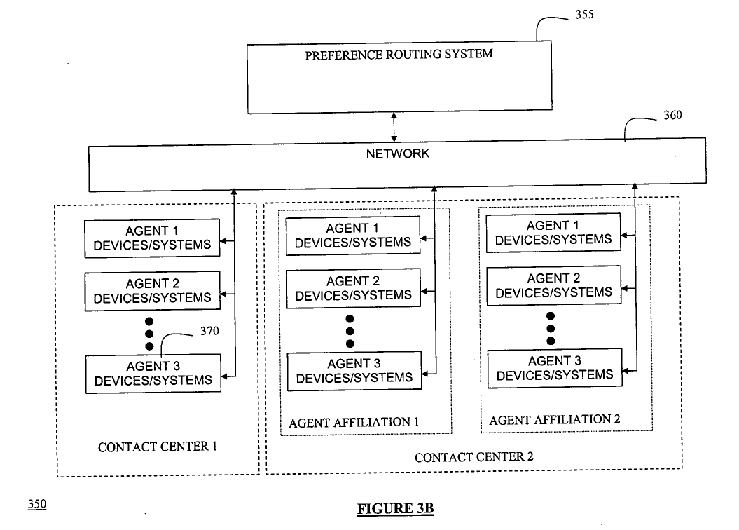

FIG. 3A depicts a hosted environment 300 in which a hosted, on-demand preference system 305 is implemented to enhance the routing of one or more remote routing systems by taking into account agent preferences in the routing. Referring to FIG. 3, the hosted, on-demand preference system is connected to a plurality of routing systems 315 over a network 310. Each routing system 315 is associated with a contact center to which a plurality of agents are connected using agent devices 320 and agent systems 325. The preference system 300 may also communicate with the agent devices 320 and agent systems 325 over the network 310. The hosted configuration of FIG. 3 permits agent preferences to be monitored by the preference system 305 and made available to each routing system 315 for routing decisions. The routing protocols for this embodiment base on agent preferences may be implemented according to any of the agent preference routing protocols described illustratively herein.

FIG. 3B depicts a hosted environment 350 in which a hosted, on-demand preference routing system 355 is implemented to route service requests based on agent preferences among a plurality of remotely located agents. The agents may have different agent affiliations and/or different locations. Referring to FIG. 3B, the hosted, on-demand preference routing system 355 is connected to a plurality of agent devices and/or systems 370 over a network 360. The hosted, on-demand preference routing system 355 has access to agent profiles which specify the agent affiliation and thus enable the system 350 to handle service requests that it receives that are directed to more than one organization and to route service requests to agents with the proper affiliation. This allows a single routing system 355 to service multiple organizations seamlessly.

Because of its network based implementation, the hosted system 355 may support agents having different affiliations in the same physical location or contact center, agents having the same affiliation in different physical locations or contact centers, or agents having different affiliations in different physical locations or contact centers as illustrated in FIG. 3B. It will be understood that the preference routing system 355 may be implemented either as a stand alone routing system, such as an ACD, equipped with routing protocols based on agent preferences as described herein or as a routing system that is influenced to perform preference based routing by a separate preference system.

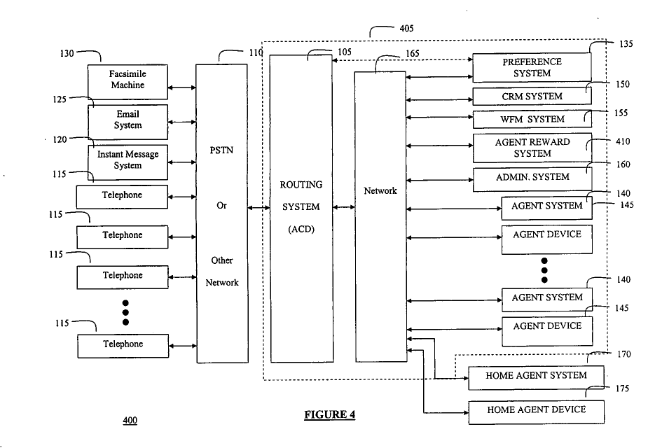

FIG. 4 depicts a service request communication system 400 facilitated by a contact center 405 according to an embodiment of the present invention which includes an agent reward system 410. The agent reward system may be implemented in any of the preference system configurations shown in FIGS. 1-3. In general, the agent reward system may be used to monitor incentives provided to agents and the acceptance of those incentives, to monitor and track the performance of agents, and to track the accumulation by agents of points, value or other incentives offered to agents through the preference system or otherwise made available to the agent by virtue of the agent's performance within the contact center. Each agent's accumulated incentives may be associated with each agent and stored in a database. The reward system may further communicate an agent's accumulated incentives or rewards to the agent in real time or on-demand. The accumulated incentives may be redeemable by agents through the reward system or through a separate system according to any convenient technique.

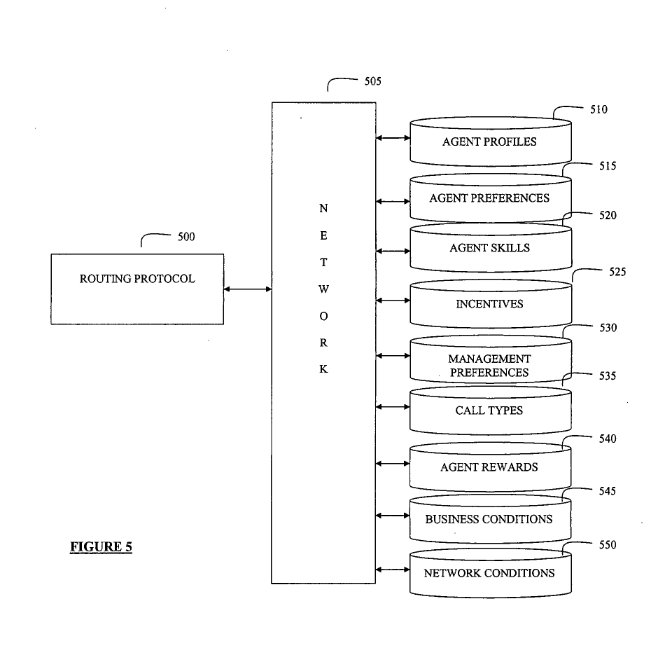

FIG. 5 depicts a plurality of inputs to a routing protocol according to an embodiment of the present invention. Referring to FIG. 5, the routing protocol 500 is coupled to a plurality of databases 510-550 over a network 505. Each of the databases may provide information that is used by the routing protocol 500 to make routing decisions relating, for example, to identifying the agent to which an inbound call should be routed or when an agent becomes available, the agent to which a queued call should be routed. The databases 510-550 may be part of the same database, or conversely, one or more of the databases 510-550 may be stored in separate databases.

The routing protocol 500 may be embodied in software or in hardware on a single system or in multiple systems. When in software, the routing protocol may be loaded into the memory of a system, such as a server or computer system, and executed by the system to perform the functions of the routing protocol.

The agent profiles database 510 may include information on the agent's identity and availability. The agent preferences database and agent skills database 515 and 520, respectively, may be part of or distinct from the agent profile database. In general, the agent skills database is used to identify an agent's skills in terms of types of service requests that the agent can handle. The skills may include, for example, handling service requests in particular language; handling sales inquiries; handling technical support inquiries; and handling customer service inquiries. Moreover, each skill may have associated with it an indication of whether the skill is primary or secondary and perhaps a priority level for the skill. The priority level of a skill may be cardinal or ordinal. The skill information stored for each agent may illustratively include any information used to differentiate one agent's skills from another in terms of the agent's ability to handle service requests and to prioritize an agent's skills relative to other skills of that agent and the agent's skills relative to other agents. The agent profile database may further include information describing the agent's contact center (or other organizational) affiliation and contact information.

The agent preferences database 515 includes agent preference information that each agent may declare to influence the routing of service requests to the agent. In general, the agent preference information relates to particular call types or particular skills of the agent. The agent preference information may be expressed in any number of ways and the expression of agent preference information is not intended to be limited to any particular expression. Agent preference information may be expressed by the agent, for example, by ordering the agent's skills from most preferred to least preferred. Alternatively, an agent may assign a preference score to each skill. The scores corresponding to each skill may be used to eliminate a skill from consideration if desired or to give a preference weight relative to other skills. The agent preference information may be more complex, formulaic or conditional if desired.

The incentives database 525 may include incentive information relating to particular incentives that call center management has to offer agents. The incentives may include points, value such as monetary compensation, time off from work, prizes or any other form of incentive. The incentive information may be general in nature or may be associated with any aspect of call center performance, such as, for example, incentives for handling particular calls, particular call types, performance of a particular agent, performance of a particular team of agents, performance of the call center, foregoing agent idle time, agent availability, agents working non-scheduled shifts or any other incentives.

The management preferences database 530 includes management preference information that may be used by management to influence, together with agent preferences, the routing of service requests to the agent. In general, the management preference information relates to particular call types or particular skills of the agent. Just like agent preferences, the management preferences may be expressed in any number of ways and the expression of management preferences is not intended to be limited to any particular expression. Management preference information may be expressed by management, for example, by ordering the call types or skills from most preferred to least preferred. Alternatively, management may assign a preference score to each skill or call type. The scores corresponding to each skill or call type may be used to eliminate a skill from consideration if desired or to give a preference weight relative to other skills. The management preference information may be more complex, formulaic or conditional if desired and may be offered to all agents or may be tailored for each agent.

The call types database 535 may be used to store information relative to service request types that the contact center expects to handle. The service requests types may include, for example, different types of languages associated with contacts such as calls that the contact center is equipped to handle. The service request types may further include classifications such as sales inquiry, technical support, customer service, sales promotion 1 and sales promotion 2. At any given time, there may be one ore more sales promotions that require special agent skills or training to handle. The routing system classifies incoming service requests to the call center according to one of the service request types to facilitate processing the service request.

The agent reward database 540 may include, for each agent, reward information relating to the accumulation of incentives by agents. The reward information may be provided to agents via the reward system in real time. Alternatively, the reward information may be retrieved and provided to agents in any convenient manner.

The business conditions database 545 may include output from the CRM, such as any information on the performance of one or more contact centers which may be used by a routing protocol to alter the routing. As such, the business conditions database may include information on whether business conditions are being met, information about the customer making particular requests, information about the importance of each service request and other information.

The network conditions database 550 may include output from the ACD. Accordingly, it may store information pertaining to the number of queued service requests of each type, the number of available agents, the throughput of each type of service requests and any other type of information that reflects the performance of routing that may be used to adjust the routing protocol.

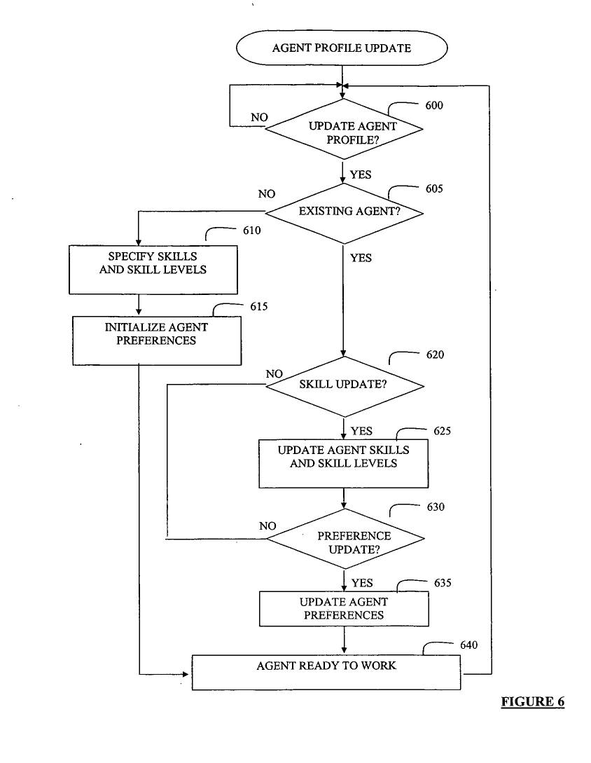

FIG. 6 depicts a method of updating an agent's profile according to an embodiment of the present invention. Referring to FIG. 6, in step 600, a system determines whether an update of an agent's profile is required. An update in an agent's profile may be required when a contact-center administrator interacts with work force management software to define a new agent working at the contact center or a new work schedule for an existing agent. Alternatively, an update in an agent's profile may be required when an agent interacts with a preference system to update the agent's skills or the agent's preferences with respect to schedule, occupancy or any other attribute of the agent that may be used in routing. If there is no update in any agent's profile, the agent profile flowchart waits for an update request.

Once an agent profile update requests is received, then in step 605, the system determines whether the agent for whom a profile update is requested is an existing agent. If not, then step 610 begins. In step 610, an administrator or other person specifies agent information, including the agent's skills and skill levels. Then in step 615, the system initializes the agent's preferences. This may be performed by setting them to a default value or a value specified by the agent. After step 615, step 640 may begin and the agent, having been properly defined to the contact center, is ready to work.

If the agent is an existing agent in step 605, then an existing agent is in the process of updating the agent's preferences or skills, and step 620 begins. In step 620, the system determines whether a skill has been updated. This may be performed by an agent or contact-center management. If not then step 630 begins. If so, then step 625 begins. In step 625, the system updates the agent's skills and/or skill levels based on input from the agent or contact-center management. Then step 630 begins.

In step 630, the system determines whether an agent requests a preference update or otherwise whether an agent preference update is required. If not, then step 640 begins and the agent is ready to work based on the agent's previous preferences. If the agent makes a preference update, then in step 635, the system updates the agent preferences according to information provided by the agent. In step 640, the agent is ready to work based on any new skills or preferences expressed during the agent profile update procedure illustrated in FIG. 6.

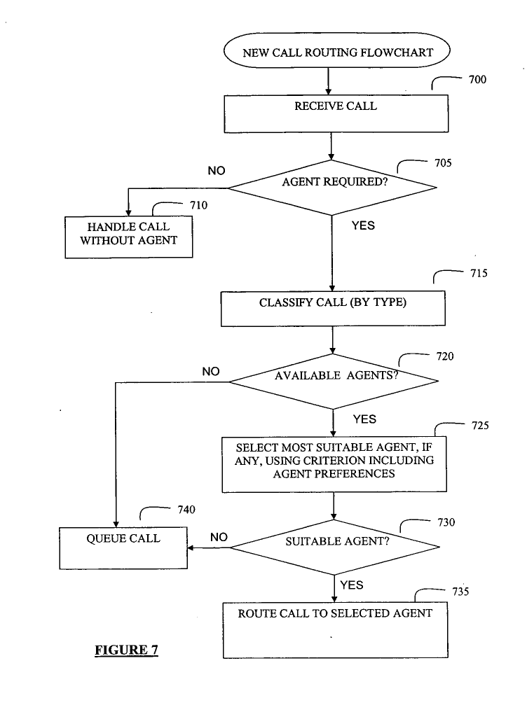

FIG. 7 depicts a method of routing a new service request, such as a call, received by a contact center. Referring to FIG. 7, in step 700, the routing protocol determines that a new call or other service request has been received by the contact center. Then in step 705, the protocol determines whether an agent is required. If no, the call or other service request may be handled in step 710 without assigning an agent. This may occur, for example, through the use of an interactive voice response (IVR) unit, also called a voice response unit (VRU), in the case of an inbound telephone call.

If in step 705 an agent is determined to be required, then step 715 begins. In step 715, the routing protocol classifies the call or service request by type. The classification may be made into one or more categories. The classification types may be any convenient type that distinguishes one call from another, preferably in a way that corresponds to distinctions in skills among the pool of agents. The call (or service request) types may include, for example, sales inquiry, technical support, customer service, sales promotion 1 and sales promotion 2, English language, French language, Spanish language and any other convenient categories.

Then in step 720, the routing protocol determines whether there are any available agents. If not, then step 740 begins and the call is placed into a call queue. The call queue at any given time represents the pool of service request presently being handled by the contact center that have not yet been assigned to agents for handling. If in step 720 there are available agents, then step 725 begins.

In step 725, the routing protocol selects the most suitable agent for handling the service request using a criterion, including agent preferences. The step of selecting the most suitable agent for handling a new service request may be made based on multiple factors, of which agent preferences are one factor. Other factors may include: i) load-based routing factors, such as which agent has been idle the longest; ii) skill-based routing factors, such as which agents have the requisite skills to handle the service request, whether the skill is primary or secondary for the agent as well as any weighting of the agent's skill; iii) management preferences for each agent; iv) network conditions, such as the quantity of each type of service request; v) the acceptance of any incentives by agents; vi) and any other convenient factor. In step 730, the routing protocol determines whether there is a suitable agent. If not, then step 740 begins and the call or service request is placed in the queue. If there is a suitable agent, then in step 735 the call or service request is routed to the agent selected in step 725.

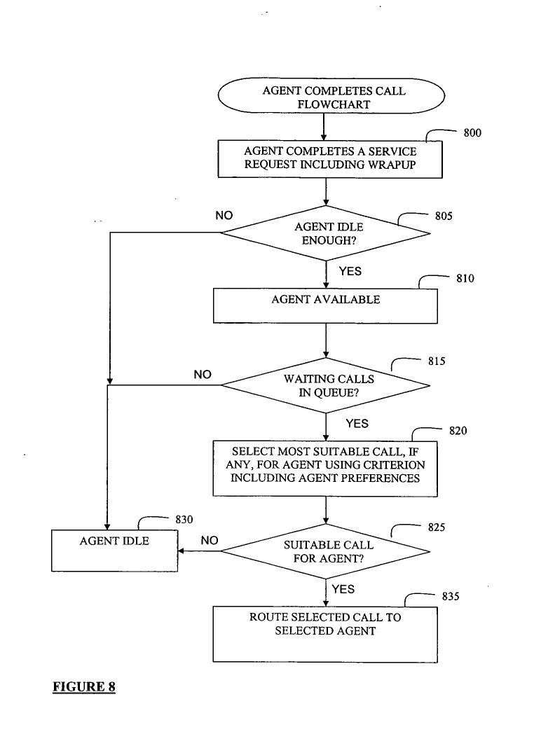

FIG. 8 depicts a method of routing a call from a service request queue within a contact center to an agent after the agent completes a call or finishes handling a service request. Referring to FIG. 8, in step 800, a routing protocol determines that an agent completes a call or finishes handling a service request. Then in step 810, the protocol determines whether the agent has been idle enough over a relevant time period. This is known as determining the agent's occupancy and is used to ensure that agents have a certain amount of idle time over the course of a time period. The idle time threshold for any given time period above which an agent becomes available may be set by management and optionally adjusted by agent preferences, in response to incentives, according to an embodiment of the present invention. Alternatively, the occupancy or a minimum threshold value for the occupancy may be fixed by contact-center policy. If the agent has not been idle long enough, then step 830 begins and the agent remains idle for a period of time. If the agent has been idle long enough in step 805, then step 810 begins. In step 810, the agent becomes available for handling service requests.

In step 815, the protocol determines whether there are calls or service requests waiting in the service request queue for handling. If not, then step 830 begins and the agent remains idle. By contrast, if there are calls or service requests in the queue, then step 820 begins. In step 820, the routing protocol selects the most suitable call for the agent using parameters, including agent preferences. The step of selecting the most suitable call for the agent may be made based on multiple factors (or parameters), of which agent preferences are one factor. Other factors may include: i) load-based routing factors, such as which call has been waiting the longest; ii) skill-based routing factors, such as which calls the agent has the requisite skills to handle, whether the skill is primary or secondary for the agent as well as any weighting of the agent's skill; iii) management preferences for each agent; iv) network conditions, such as the quantity of each type of call or service request; v) the acceptance of any incentives by agents; vi) and any other convenient factor.

Then in step 825, the protocol determines whether there are any suitable calls for the agent. If not, then the agent remains idle in step 830. If there is a suitable call or service request for the agent in step 825, then step 830 begins and the call or service request is routed to the selected agent.

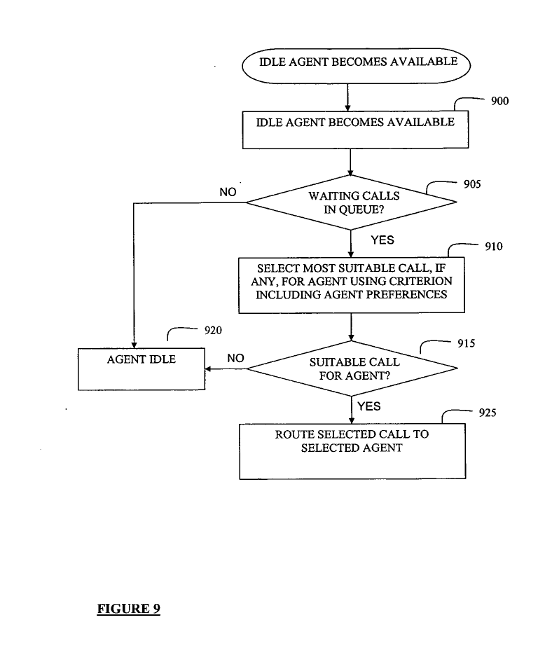

FIG. 9 depicts a method of routing a call from a service request queue within a contact center to an agent after an idle agent becomes available. Referring to FIG. 9, in step 900, a routing protocol determines that an idle agent becomes available because, for example, the agent finishes a break, because the agent's occupancy drops below a threshold or the agent otherwise is designated as available. Then in step 905, the routing protocol determines whether there are calls or service requests waiting in the queue. If not, then the agent remains idle and available. If there are calls or service requests waiting in the queue, then step 910 begins.

In step 910, the routing protocol determines the most suitable call or service request for the agent to handle using criterion, including agent preferences. The selection may be performed in the same manner as that described relative to step 820. If there is no suitable call or service request for the agent to handle, then step 920 begins. In step 920, the agent remains idle. If there is a suitable call or service request for the agent to handle, then step 925 begins and the selected call or service request is routed to the newly idle agent.

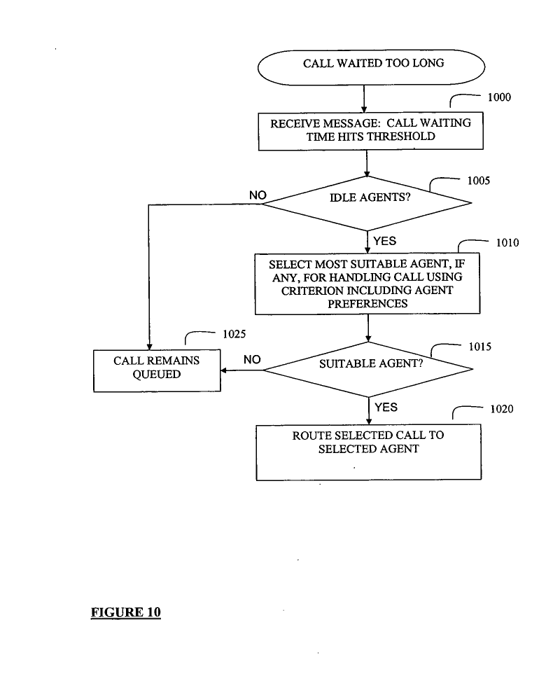

FIG. 10 depicts a method of routing a call that has waited too long from a service request queue to an available agent. Referring to FIG. 10, in step 1000, a routing protocol receives a message that a call or service request waiting time reaches or passes a predetermined threshold. Then in step 1005, the protocol determines whether there are any idle agents. If not, then in step 1025, the call or service request remains in the queue. If there are idle (or available) agents in step 1005, then step 1010 begins.

In step 1010, the protocol determines the most suitable agent, if any, using criterion including agent preferences. The determination made in step 1010 may be made according to the same considerations as those described as associated with step 725. Alternatively, the routing considerations for step 1010 may be loosened to permit routing a call to agents that lack skills to handle the particular call type or that list those skills as either not preferred or as secondary or lower skills. The aim here is to route customer calls or service requests that have become stale to an agent who can at least respond, even if the agent lacks the skills or degree of proficiency with the skills to effectively handle the service request. The extent to which step 1010 compromises agent skills in order to favor routing the service request to an agent is a threshold that may be adjusted to achieve any desired outcome. In step 1015, the protocol determines whether there are any suitable agents. If not, then step 1025 begins and the service request or call remains in the queue. If so, then step 1020 begins and the service request is routed to the selected agent.

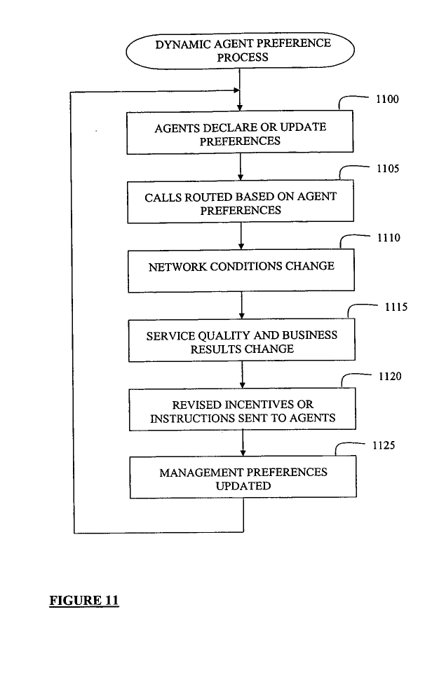

FIG. 11 depicts a method of dynamically influencing routing within a call center based on incentives and agent preferences and other available information and constraints. Referring to FIG. 11, in step 1100, agents declare their preferences for handling certain types of calls (or for using certain agent skills). This declaration may be made by the agent through interaction with the agent systems 140 or home agent systems 170.

In general, the agent systems may include hardware, firmware, software or other program instructions that provide an agent preference interface to agents that allows agents to declare preferences for handling different types of calls for which the agents have corresponding skills. The agent preference interface may comprise a selectable toolbar on a computer screen, a web browser interface or any other convenient interface. The agent preference interface further may include a screen, display or portion thereof, a speaker, or any other output device that provides information from the contact center to the agent, such as incentives for: handling particular types of calls, increasing (or decreasing) agent availability in terms of the agent's working schedule, increasing (or decreasing) agent occupancy, or adjusting the agent preferences.

The agent preference interface may provide to the agent at any given time the agent's preferences and may permit the agent to update the agent's preferences at any given time. Alternatively, the agent preference interface may only allow the agent to adjust agent preferences at predetermined times or intervals or asynchronously in response to changing network conditions or other signal from the call center or its management. Such a signal may include, for example, management posting new incentives for handling different types of service requests. Combinations may also be implemented. For example, the agent preference interface may permit the agents to participate in rounds that are initiated by management providing incentives. The rounds may be set to occur at particular times. Upon the completion of one or more rounds, pursuant to which agents are permitted to adjust preferences, the agent preference choices may be fixed until a subsequent round. Alternatively, the agent preferences at any given time may be altered. The agent preference interface may communicate preference information to the preference system which it is stored at appropriate times and designated for use as up to date agent preference information for use by the routing protocol.

In step 1105, calls or service requests are routed based on the agent preference information. The routing of the calls or service requests dynamically changes as the agent preferences are altered by agents in rounds, asynchronously or according to any other scheme. In step 1110, the network conditions within the call center change. The changes in the network conditions of the contact center occur because the agent preference information changes and this affects the routing of queued and new service requests, such as calls. In addition, the network conditions change because of the changing, real time demands placed on the contact center by customers making service request demands. Thus at any given time, demand for contact-center resources reflected in new and queued service requests may be increasing, decreasing rapidly or slowly and particular types of service requests may be increasing or decreasing rapidly or slowly relative to other types of service requests and relative to the total volume of service requests being handled by the contact center. In addition, at any given time, the number of available agents may be increasing or decreasing slowly or rapidly and the number of available agents having particular skills may be increasing or decreasing relative to agents having other skills or relative to the total number of agents.

In step 1115, the service quality and business results achieved by the contact center change as a result of changing network conditions. These changes are monitored and tracked by the CRM and WFM systems. Moreover, this information from the CRM and WFM systems, together with information on the network conditions, may be made available to agents through agent systems and the agent preference interface and to management through the administrative system 160.

Based on the changing network conditions, service quality and business results, in step 1120, management may change the incentives associated with any aspect of contact-center performance, including the incentive for agents to handle particular types of calls. Management may also transmit instructions to agents regarding handling particular types of calls. Management may use a management preference interface, which may comprise hardware, software, firmware or program instructions associated with the administrative system 160 in order to communicate incentives and/or instructions to the agent systems, the preference system 135 or the preference routing system 205, and the agent reward system 400. Alternatively, incentives and/or information may be sent automatically in response to changing network conditions by the CRM, WFM or other tracking system.

In step 1125, management may further update management preferences for example through the management preference interface. The management preferences may be updated at any time based on the same considerations as the updating of agent preferences previously described. In addition, the management preference interface may communicate management preferences to the preference system 135 or 205 and optionally to the agent preference interfaces at any convenient time. The management preferences, taken together with the agent preferences and other routing factors, may be used to dynamically affect the routing.

Step 1100 begins again and allows agents to update their preferences based on information available, including instructions, incentives, network conditions, service quality, business results and based on any other factor the agent decides to consider. It will be understood that while FIG. 11 has been illustrated as a loop, the steps may occur in a different order or simultaneously and may occur continuously or with one or more parts in intervals, rounds or at other times.

### EXAMPLE 1

### Marketplace

The dynamic expression of agent preferences in FIG. 11 occurs in a contact center on a continual basis. Contact-center management monitors the performance of the contact center through the WFM system, the CRM system, the administrative system, the preference system, the ACD and/or any other system capable of presenting information about aspects of the performance of the contact center. The contact center handles different types of service requests.

Assume that during operation of the contact center, one type of service request suddenly increases and the call center begins queuing this type of service request. As the volume of this particular type of service request in the queue of the ACD increases, network condition information is communicated to the preference server reflecting the increase, and management adjusts incentives provided to the agents for handling this type of service request. The incentive is in the form of redeemable points. This has a tendency to cause agents to increase their preferences for handling this type of service request and causes an increase in the routing of this type of service request to the agent pool relative to other types of service requests. Agents who handle this types of service request accumulate points, which the agents can later redeem.

### EXAMPLE 2

### Incentive for Agent Staffing

During operation of a contact center, the contact center experiences a significant increase in two types of service requests. The increase is significant enough to exceeds the ability of the available pool of agents to handle the service requests appropriately. Management becomes aware of the increase through network conditions communicated from the ACD to the preference server and/or forecasting information from the WFM system. This causes management to increase incentives offered for agents to become staffed or otherwise increase their availability to handle the increased volume.

Some agents who are not scheduled to work have a preference level set that corresponds to their willingness to be staffed outside of their normal schedule in response to incentives offered by management. If the incentives offered by management exceed the preference level of the agent for unscheduled staffing, the agent has appropriate skills, and the contact-center management determines that additional agents are required, then the agent is notified and may become available to handle one or both types of service request as long as the need exists (or the agent prefers). Such an agent may use a home telephone device and/or system to handle service requests. In some contact centers, the agents may be permitted to adjust their unscheduled staffing preferences at any time and may further be permitted to specify different preferences for different skills with respect to unscheduled staffing. In this way embodiments of the present invention go beyond routing based on agent preferences to achieve staffing based on preferences. It will be understood that an agent's preferences may also be used to decrease an agent's availability during a period of time during in which the agent is already staffed or to prevent an agent from being staffed at all. The latter cases may be significant when a contact center experiences periods of low demand for service request.

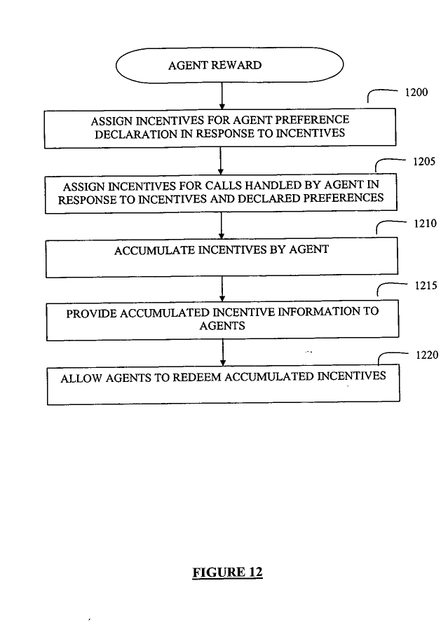

FIG. 12 depicts a method of monitoring and providing rewards to agents according to an embodiment of the present invention. Referring to FIG. 12, in step 1200, the reward protocol stores credits information accumulated by each agent for the agent's preference declaration in response to incentives offered. The credit information might represent points, value or prizes. In step 1205, the reward protocol stores credit information for each agent for calls handled by the agent in response to incentives offered to the agent. In step 1210, the reward protocol accumulates credit information by agent. In step 1215, the accumulated credit information on an agent by agent basis may be provided to agents. Then in step 1220, the reward protocol may allow agents to redeem accumulated credits reflected in the credit information. The reward protocol may be implemented in hardware, firmware, software or program instructions in whole or in part by the reward system 160 or preference system 135 or combinations thereof depending on the embodiment of the invention.

Having described the system and particular protocols for routing service requests based on agent preferences, it is useful to consider some examples of contact-center routing according to the principles described herein.

Implementing Agent Preferences in Routing Systems

A. Preference System Influencing a Conventional ACD

According to one embodiment of the present invention, a conventional ACD may be converted into a preference based ACD (a preference routing system 205) by replacing the priority matrix associated with the ACD with one that takes account of agent preferences. The priority matrix is a matrix used by many conventional ACD's to assign priorities to different skills of an agent. Conventional ACD's, however, do not take into account agent preferences in developing the priority matrix. By replacing or updating the priority matrix of a conventional ACD with a new priority matrix that takes into account agent preferences, the ACD will route service requests in a conventional manner using load and skill based routing considerations, but will also route service requests based on agent preferences that are built into the priority matrix. The priority matrix is updated in real time according, for example, to the protocol shown and described relative to FIG. 11 in order to account for changes in agent preferences (and management preferences) in real time.

For illustrative purposes, assume that there are a total of five service request types and that the priority matrix of a conventional ACD assigns priority levels to three of the five skills for each agent. These three skills are designated 3, 2, and 1 respectively to indicate the priority level. The remaining skills are either set to 0 when the agent possesses the capability but not a corresponding priority or to −1 when the agent does not possess the skill. Conventionally, management determines and sets the agent's priority levels independent of the agent.

According to the present invention, the agent is given control over the agent preferences for each skill which translate to varying degrees into priority levels for the skills. In particular, and in its most basic form, the agents select which three skills to prioritize and choose the ranking thus allowing the agents to express their preferences. Without more, this allows agents a high degree of control over routing through the expression of preferences.

In a more complex form, the priority corresponding to an agent's skills are formed as a function not only from agent preferences, but also from management preferences and any other desired parameter. A simple illustration is a multiplication of agent preferences and management preferences to yield a score that may then be converted to the 3, 2, 1 priority scheme by a simple mapping function. In an even more complex form, both the agent's preferences and the management preferences may be weighted prior to combining them. This enables management, by adjusting the weighting applied to the agent preferences, to in effect control the influence of the agent preferences in the routing process and even disable the application of agent preferences if desired. Management may similarly adjust the weighting applied to the management preferences to in effect control the influence of management in the routing process and even disable the application of management preferences if desired—for example when the contact center is experiencing low service request volume.

In a more complex form, the agent priority matrix may be generated as a function of agent preferences, management preferences and other parameters, all subject to certain management constraints. The management constraints might include restricting the number of agents that have each skill at each priority level to within certain bounds; restricting the number agents that have combinations of skills at particular combinations of priority levels to within certain bounds. Once the constraints and other parameters, including agent preferences are defined, the preference system determines the priority matrix as the solution of an integer mathematical program, maximizing the total value subject to the constraints, in a well known manner and stores the priority matrix in the preference database and/or provides the priority matrix directly to the ACD. The priority matrix may be calculated periodically, every time that there is a change in agent preference or management preference or at any other convenient time.

The conventional ACD then routes calls based on the priority matrix established by the preference system based on agent preferences. In this manner, a separate preference system may be used to alter the routing performed by a conventional ACD.

B. Preference Routing System

When the routing system itself is being redesigned to take into account agent preferences, there is flexibility to use agent preferences, skills, management preferences and any other parameters to influence routing directly. Thus, it is not necessary (although it may be done) to calculate a priority matrix that is used by the routing system. Rather, the routing system may directly determine to which agent to route calls as a function of agent preference and any other parameter, all subject to routing constraints defined by management. The same weighting considerations, composite functions and constraints may be employed in the direct preference based routing scenario as in the indirect preference based routing scenario.

While particular embodiments of the present invention have been described, it will be understood by those having ordinary skill in the art that changes may be made to those embodiments without departing from the spirit and scope of the present invention. In particular, it will be understood that any of the protocols illustrated and described herein may be implemented as program instructions which are executed by any type of computer system in order to cause the computer system to perform the functions of the protocol. Moreover, it will be understood that while the invention has been depicted as involving several systems having intimate or remote couplings via one or more intervening networks, the protocols described herein may be consolidated in one or more of the systems, or distributed over the systems depicted, or other systems, in order to achieve contact-center routing based on agent preferences, to collect and store agent preferences, to collect and store management preferences, to distribute incentives and instructions to agents, and to accumulate agent rewards.

It will be further understood that the order of any protocols depicted herein may be changed and that the agent preferences may be made available to the routing algorithm directly or indirectly to effect routing based on agent preferences according to embodiment of the present invention.

What is claimed is:

1. An apparatus for routing incoming service requests to agents, comprising:
a database that associates at least one agent preference with a corresponding agent among a plurality of agents; and
a routing system, coupled to the database, that receives incoming service requests and agent preferences from the database and determines to which agent to route service requests based on the agent preferences.

2. The apparatus according to claim 1,
wherein the database further associates each agent preference with a particular service request type; and
wherein the routing system further determines to which agent to route incoming service requests based on the type of each of the incoming service requests.

3. The apparatus according to claim 1, wherein the database further associates at least some agent preferences with agent availability; and
wherein the routing system further determines whether an agent is available based on at least one agent preference corresponding to agent availability.

4. The apparatus according to claim 3, wherein the agent availability specifies that the agent is staffed.

5. The apparatus according to claim 1, wherein the database dynamically receives updates of the agent preferences from the agents.

6. The apparatus according to claim 1, wherein the routing system further determines to which agent to route incoming calls based on management preferences.

7. The apparatus according to claim 1, wherein the routing system further determines to which agent to route incoming calls based on network conditions.

8. The apparatus according to claim 1, wherein the routing system further determines to which agent to route incoming calls based on business conditions being met.

9. The apparatus according to claim 1, wherein the agents are remotely located from the routing system and at least some of the agents have different contact center affiliations.

10. The apparatus according to claim 1, wherein the routing system further determines to which agent to route incoming calls based on at least one agent skill.

11. The apparatus according to claim 1, wherein the routing system further determines to which agent to route incoming calls based on load.

12. The apparatus according to claim 1, wherein the routing system further determines to which agent to route incoming calls based on priority.

13. The apparatus according to claim 1, wherein the service requests are telephone calls.

14. The apparatus according to claim 1, wherein the service requests are one of: facsimiles, electronic mail, and instant messages.

15. The apparatus according to claim 1, wherein at least some of the agent preferences are determined dynamically based on input received from agents in response to network condition information.

16. The apparatus according to claim 1, wherein the agents are dynamically provided with incentive information and wherein at least some of the agent preferences are determined dynamically based on input received from agents in response to the incentive information.

17. The apparatus according to claim 1, wherein the agents are awarded, based on expressing certain agent preferences, credit comprising at least one of (points, value, and prizes).

18. The apparatus according to claim 1, wherein the agents are awarded, based on handling certain service requests, credit comprising at least one of (points, value, and prizes).

19. The apparatus according to claim 1, wherein the routing system further determines to which agent to route service requests based on values that are determined as a function of multiple parameters, of which agent preferences are one of the multiple parameters.

20. An apparatus for affecting service request routing by a routing system, comprising:
a database for storing agent preferences associated with agents; and
a server capable of communication with the database and a routing system and being capable of receiving preferences from agent terminals and storing the preferences in the database;
wherein the server provides preference information corresponding to the agent preferences to the routing system to permit service request routing by the routing system based on the preference information.

21. The apparatus according to claim 20, wherein the routing system comprises an automatic call distributor (ACD).

22. The apparatus according to claim 21,
wherein the database further associates each agent preference with a particular call type; and
wherein the ACD further determines to which agent to route incoming calls based on the call type of the incoming calls.

23. The apparatus according to claim 21, wherein the database further associates at least some agent preferences with agent availability; and
wherein the ACD further determines whether an agent is available based on at least one agent preference corresponding to agent availability.

24. The apparatus according to claim 23, wherein the agent availability specifies that the agent is staffed.

25. The apparatus according to claim 21, wherein the database dynamically receives updates of the agent preference information from the agents.

26. The apparatus according to claim 21, wherein the preference information provided by the server is determined based on agent preferences and management preferences.

27. The apparatus according to claim 21, wherein the ACD further performs call routing based on network conditions.

28. The apparatus according to claim 21, wherein the ACD further performs call routing based on business conditions being met.

29. The apparatus according to claim 21, wherein the ACD further performs call routing based on at least one of network conditions and business conditions being met.

30. The apparatus according to claim 21, wherein the agents are remotely located from the routing system and at least some of the agents have different contact center affiliations.

31. The apparatus according to claim 21, wherein the ACD further performs call routing based on at least one agent skill.

32. The apparatus according to claim 21, wherein the ACD further determines to which agent to route incoming calls based on load.

33. The apparatus according to claim 21, wherein the ACD further determines to which agent to route incoming calls based on priority.

34. The apparatus according to claim 21, wherein the service requests are telephone calls.

35. The apparatus according to claim 21, wherein the service requests are one of: facsimiles, electronic mail, and instant messages.

36. The apparatus according to claim 21, wherein at least some of the agent preferences are determined dynamically based on input received from agents in response to network condition information.

37. The apparatus according to claim 21, wherein the agents are dynamically provided with incentive information and wherein at least some of the agent preferences are determined dynamically based on input received from agents in response to the incentive information.

38. The apparatus according to claim 21, wherein the agents are awarded, based on expressing certain agent preferences, credit comprising at least one of (points, value, and prizes).

39. The apparatus according to claim 21, wherein the agents are awarded, based on handling certain service requests, credit comprising at least one of (points, value, and prizes).

40. The apparatus according to claim 21, wherein the ACD further determines to which agent to route service requests based on values that are determined as a function of multiple parameters, of which agent preferences are one of the multiple parameters.

41. A method for routing incoming service requests to agents, comprising:
associating at least one preference of at least one agent with a corresponding agent among a plurality of agents;
receiving service requests; and
determining to which agent to route the service requests based on the agent preferences.

42. The method according to claim 41, further comprising:
associating the agent preferences with corresponding service request types; and
wherein the determining is further performed based on the type of the incoming service requests.

43. The method according to claim 41, wherein the database further associates at least some agent preferences with agent availability; and
wherein whether an agent is available is determined based on at least one agent preference corresponding to agent availability.

44. The method according to claim 43, wherein the agent availability specifies that the agent is staffed.

45. The method according to claim 41, wherein the database dynamically receives updates of the agent preferences from the agents.

46. The method according to claim 41, wherein the determining is further based on management preferences.

47. The method according to claim 29, wherein the determining is further based on network conditions.

48. The method according to claim 41, wherein the ACD further performs call routing based on business conditions being met.

49. The method according to claim 41, wherein the determining is further based on at least one agent skill.

50. The apparatus according to claim 41, wherein the ACD further determines to which agent to route incoming calls based on load.

51. The apparatus according to claim 41, wherein the ACD further determines to which agent to route incoming calls based on priority.

52. The method according to claim 41, wherein the service requests are telephone calls.

53. The method according to claim 41, wherein the service requests are one of: facsimiles, electronic mail, and instant messages.

54. The method according to claim 41, wherein at least some of the agent preferences are determined dynamically based on input received from agents in response to network condition information.

55. The method according to claim 41, wherein the agents are dynamically provided with incentive information and wherein at least some of the agent preferences are determined dynamically based on input received from agents in response to the incentive information.

56. The method according to claim 41, wherein the agents are awarded, based on expressing certain agent preferences, credit comprising at least one of (points, value, and prizes).

57. The method according to claim 41, wherein the agents are awarded, based on handling certain service requests, credit comprising at least one of (points, value, and prizes).

58. The method according to claim 41, wherein the determining further comprises determining to which agent to route service requests based on values that are calculated as a function of multiple parameters, of which agent preferences are one of the multiple parameters.

59. A computer program product having computer program logic stored therein, comprising:
associating logic for causing a computer to associate at least one preference with a corresponding agent among a plurality of agents;
receiving logic for causing the computer to receive information about service requests; and
determining logic for causing the computer to determine to which agent to route the service requests based on the information and the agent preferences.

60. The computer program product according to claim 59,
wherein the associating logic further causes the computer to associate the agent preferences with corresponding service request types; and
wherein the determining logic further causes the computer to perform the determining based on the type of the incoming service requests.

61. The computer program product according to claim 59,
wherein the associating logic further causes the computer to associate the agent preferences with agent availability; and
wherein the determining logic further causes the computer to perform the determining based on at least one agent preference corresponding to agent availability.

62. The computer program product according to claim 61, wherein the agent availability specifies that the agent is staffed.

63. The computer program product according to claim 59, wherein the associating logic causes the computer to dynamically receive updates of the agent preferences from the agents.

64. The computer program product according to claim 59, wherein the determining logic further causes the computer to determine to which agents to route incoming service requests based on management preferences.

65. The computer program product according to claim 59, wherein the determining logic further causes the computer to determine to which agents to route incoming service requests based on network conditions.

66. The computer program product according to claim 59, wherein the determining logic further causes the computer to determine to which agents to route incoming service requests based business conditions being met.

67. The computer program product according to claim 59, at least some of the agents have different contact center affiliations.

68. The computer program product according to claim 59, wherein the determining logic further causes the computer to determine to which agents to route incoming service requests based on at least one agent skill.

69. The computer program product according to claim 59, wherein the determining logic further causes the computer to determine to which agents to route incoming calls based on load.

70. The computer program product according to claim 59, wherein the determining logic further causes the computer to determine to which agents to route incoming calls based on priority.

71. The computer program product according to claim 59, wherein the service requests are telephone calls.

72. The computer program product according to claim 59, wherein the service requests are one of: facsimiles, electronic mail, and instant messages.

73. The computer program product according to claim 59, wherein at least some of the agent preferences are determined dynamically based on input received from agents in response to network condition information.

74. The computer program product according to claim 59, wherein the agents are dynamically provided with incentive information and wherein at least some of the agent preferences are determined dynamically based on input received from agents in response to the incentive information.

75. The computer program product according to claim 59, wherein the agents are awarded, based on expressing certain agent preferences, credit comprising at least one of (points, value, and prizes).

76. The computer program product according to claim 59, wherein the agents are awarded, based on handling certain service requests, credit comprising at least one of (points, value, and prizes).

77. The computer program product according to claim 59, wherein the determining logic further causes the computer to determine to which agent to route service requests based on values that are calculated as a function of multiple parameters, of which agent preferences are one of the multiple parameters.

78. An apparatus for affecting service request routing performed by multiple ACDs, comprising:
a database for storing agent preferences for agents, wherein each agent is associated with a particular organization and wherein the database stores agent preferences for a plurality of organizations; and
a server capable of communication with the database and a plurality of ACDs corresponding to a plurality of organizations and being capable of receiving preferences from agent terminals and storing the preferences in the database;
wherein the server provides the preference information for each agent to each ACD to permit service request routing by a plurality of ACDs to be performed based on the agent preferences.

79. The apparatus according to claim 78,
wherein the database further associates each agent preference with a particular call type; and
wherein each ACD further determines to which agent to route incoming calls based on the call type of the incoming calls.

80. The apparatus according to claim 78, wherein the database further associates at least some agent preferences with agent availability; and
wherein each ACD further determines whether an agent is available based on at least one agent preference corresponding to agent availability.

81. The apparatus according to claim 80, wherein the agent availability specifies that the agent is staffed.

82. The apparatus according to claim 78, wherein the database dynamically receives updates of the agent preference information from the agents.

83. The apparatus according to claim 78, wherein the preference information provided by the server is determined based on agent preferences and management preferences.

84. The apparatus according to claim 78, wherein each ACD further performs call routing based on network conditions.

85. The apparatus according to claim 78, wherein each ACD further performs call routing based on business conditions being met.

86. The apparatus according to claim 78, wherein each ACD further performs call routing based on at least one agent skill.

87. The apparatus according to claim 78, wherein each ACD further performs call routing based on load.

88. The apparatus according to claim 78, wherein each ACD further performs call routing based on priority.

89. The apparatus according to claim 78, wherein the service requests are telephone calls.

90. The apparatus according to claim 78, wherein the service requests are one of: facsimiles, electronic mail, and instant messages.

91. The apparatus according to claim 78, wherein at least some of the agent preferences are determined dynamically based on input received from agents in response to network condition information.

92. The apparatus according to claim 78, wherein the agents are dynamically provided with incentive information and wherein at least some of the agent preferences are determined dynamically based on input received from agents in response to the incentive information.

93. The apparatus according to claim 78, wherein the agents are awarded, based on expressing certain agent preferences, credit comprising at least one of (points, value, and prizes).

94. The apparatus according to claim 78, wherein the agents are awarded, based on handling certain service requests, credit comprising at least one of (points, value, and prizes).

95. The apparatus according to claim 78, wherein each ACD further determines to which agent to route service requests based on values that are determined as a function of multiple parameters, of which agent preferences are one of the multiple parameters.

96. A method of rewarding agents in real time, comprising:
identifying calls handled by each agent based on agent preferences;
assigning points to each agent based on calls handled by the agent; and
storing a point total for each agent.
